(19) United States
(12) Patent Application Publication
(10) Pub. No.: US 2023/0271715 A1
(43) Pub. Date: Aug. 31, 2023

(54) CRYOGENIC LIQUID TANK FOR AN AIRCRAFT AND METHOD FOR MANUFACTURING THE SAME

(71) Applicant: Airbus SAS, BLAGNAC (FR)

(72) Inventors: Alois FRIEDBERGER, BLAGNAC (FR); Jürgen SILVANUS, BLAGNAC (FR)

(21) Appl. No.: 18/164,660

(22) Filed: Feb. 6, 2023

(30) Foreign Application Priority Data
Feb. 28, 2022 (EP) 22159269.4

(51) Int. Cl. B64D 37/04; F17C 1/12

(52) U.S. Cl. CPC B64D 37/04; F17C 1/12; F17C 2223/0161; F17C 2221/012; F17C 2250/0439; F17C 2250/0491; F17C 2203/0391; F17C 2270/0189; F17C 2209/232; F17C 2203/0646; F17C 2201/0109; F17C 2203/0629

(57) ABSTRACT

Measures for monitoring and manufacturing tanks for cryogenic liquids. The tank is manufactured in a way that signal and power lines from a control unit to sensors of the cryogenic tank are integrated with the tank walls. The conductive track structure so formed has a layer structure that uses the naturally occurring or artificially generated insulating layer on the tank wall material as a substrate on top of which conductive paths are formed that connect the sensors to the control unit.

### CROSS-REFERENCES TO RELATED APPLICATIONS

This application claims the benefit of the European patent application No. 22159269.4 filed on Feb. 28, 2022, the entire disclosures of which are incorporated herein by way of reference.

### FIELD OF THE INVENTION

The invention relates to a cryogenic liquid tank, preferably for an aircraft. The invention further relates to an aircraft equipped with such a tank and a method of manufacturing the cryogenic liquid tank.

### BACKGROUND OF THE INVENTION

Currently, optical fibers are a common approach to handle distributed measurement, i.e., measuring a parameter at several locations, e.g., with fiber bragg gratings (FBG). In principle, most of the relevant parameters in a liquid hydrogen (LH₂) tank can be measured with optical fibers. While it is a promising approach, it is not clear yet whether this approach can be developed into an accepted industry standard, in particular in the field of aircraft manufacturing.

A further current approach is using a sensor network where each sensor entity transmits the data using a wireless data transfer protocol. However, even with this approach, cables are still needed to supply electrical power, for example. There are different options for energy harvesting to avoid the cables for powering. Energy harvesting, while feasible, requires a well-tailored design for the application and may thus not always be a viable option.

EP 3 582 233 A1 discloses a method for printed cable installation in composite elements of aircraft. The method includes printing conductive paths onto carbon fiber reinforced composite parts.

### SUMMARY OF THE INVENTION

It is an object of the invention to provide improved measures for monitoring and manufacturing tanks for cryogenic liquids.

The invention provides a cryogenic liquid tank for storing cryogenic liquids, such as liquid hydrogen, the tank comprising:
a tank body having at least one tank wall that defines a cryogenic storage volume for storing a cryogenic liquid at cryogenic temperatures; and
an electrically conductive track structure that is formed on the at least one tank wall and configured for conducting electricity from a terminal to a sensor.

In an embodiment, the tank further comprises at least one sensor that is electrically coupled to the electrically conductive track structure and arranged on the tank wall.

In an embodiment, at least one sensor is integrally formed with the conductive track structure.

In an embodiment, the at least one sensor is chosen from a group consisting of:
a capacitive sensor configured for changing its capacitance depending on a physical characteristic relating to the cryogenic liquid;
a resistive sensor configured for changing its resistance depending on a physical characteristic relating to the cryogenic liquid;
a thermocouple sensor configured for generating a voltage depending on the temperature relating to the cryogenic liquid; and
a radiofrequency sensor configured for transmitting, receiving, or transceiving radio waves, so as to allow measuring a physical characteristic relating to the cryogenic liquid.

In an embodiment, the at least one tank wall comprises an inside portion that faces towards the storage volume and an outside portion that faces away from the storage volume, wherein the electrically conductive track structure is formed on the inside portion and/or outside portion.

In an embodiment, the tank body comprises an inner tank wall and an outer tank wall, wherein the inner tank wall defines the storage volume, and the electrically conductive track structure is formed on the inner tank wall and/or the outer tank wall.

In an embodiment, the inner tank wall comprises an inside portion that faces towards the storage volume and an outside portion that faces away from the storage volume, and the electrically conductive track structure is formed on the inside portion and/or the outside portion.

In an embodiment, outer tank wall comprises an inside portion that faces towards the storage volume and an outside portion that faces away from the storage volume, and the electrically conductive track structure is formed on the inside portion and/or the outside portion.

In an embodiment, the tank body comprises a vacuum cavity that encompasses the storage volume and holds a vacuum. In an embodiment, the vacuum cavity is defined between the outer tank wall and the inner tank wall.

In an embodiment the tank body and the electrically conductive track structure form a layer structure.

In an embodiment, the layer structure comprises an electrically insulating substrate layer that is part of, formed on, or attached to the at least one tank wall and an electrically conductive layer formed on the electrically insulating substrate layer so as to be electrically insulated from the at least one tank wall; and/or wherein the layer structure comprises a protective electrically insulating layer formed on top of the electrically conductive layer. In an embodiment, the electrically insulating substrate layer is adhesively bonded to the at least one tank wall. In an embodiment the electrically insulating substrate layer comprises a foil.

The invention provides a tank arrangement for an aircraft, the tank arrangement comprising a preferred tank and a control unit that is electrically coupled to the electrically conductive track structure and configured for measuring physical parameters that relate to the cryogenic liquid.

The invention provides an aircraft, preferably an airplane, comprising a preferred tank or a preferred tank arrangement.

The invention provides a method for manufacturing a cryogenic liquid tank for storing cryogenic liquids, such as liquid hydrogen, the method comprising:
a) forming a tank body that has least one tank wall, preferably out of at least one piece of plate-like metal material;
b) forming an electrically conductive track structure on the at least one tank wall of a cryogenic liquid tank, such that the electrically conductive track structure is suitable for conducting electricity from a terminal to a sensor; and
c) closing the tank wall so as to define a cryogenic storage volume for storing a cryogenic liquid at cryogenic temperatures; or
d) forming an electrically conductive track structure on a piece of plate-like metal material, such that the electrically conductive track structure is suitable for conducting electricity from a terminal to a sensor; and subsequently
e) forming the metal material into a tank body that has least one tank wall that defines a cryogenic storage volume for storing a cryogenic liquid at cryogenic temperatures.

In an embodiment step b) and/or step d) comprises oxidizing or letting oxidize the metal material so as to form an insulating substrate layer.

In an embodiment step b) and/or step d) comprises deposition of conductive material on the insulating substrate layer so as to form a conductive layer.

In an embodiment, the method further comprises a step f) of forming at least one sensor that is electrically coupled to the electrically conductive track structure on the piece of plate-like material and/or the tank wall.

Cryogenic liquid hydrogen (LH₂) tanks usually have many sensors for operation, control and safety. As a result, installation of several sensors with lots of cables is required. Each cable usually needs to be properly installed, fixed and checked. Cables and corresponding connectors that are specifically made for cryogenic temperatures are rather complex specialized products in order to ensure reliability.

Examples for typical parameters that are measured by the installed sensors are temperature, pressure, H2 gas and LH₂ level monitoring (e.g., radar antennas for fuel level monitoring). Usually, no single but distributed measurement is advantageous which further increases the amount of sensors.

The ideas presented allow reduction of harnesses by replacing the cables with conducting tracks arranged, e.g., printed, on the tank wall(s) itself.

Furthermore, the measures presented herein provide an independent second measurement principle to the known ones, thereby enabling a check on each other. In other words, different sensors are installed in addition to optical fibers, for example, and connected for power and data transfer.

In an embodiment replacement of conventional cables by printing conductive tracks directly on the tank wall is possible.

This can be done on different portions of the tank wall(s), such as inside the inner tank wall for sensors installed on the inner tank wall surface; and/or outside the inner tank wall for sensors installed on the outside surface of the inner tank wall; and/or inside the outer tank wall for sensors installed on the inner surface of the outer tank wall; and/or outside the outer tank wall for sensors installed on the outer side of the outer tank wall.

Usually, inside the inner tank wall sensors and conductive tracks are exposed to gaseous hydrogen or LH₂ at a temperature of about 20 K. On the outside of the inner tank wall sensors and conductive tracks are exposed to vacuum at a temperature of about 20 K. The inside of the outer tank wall typically exhibits a “normal” temperature, i.e., a non-cryogenic temperature, for the sensors and tracks, however including a vacuum. The outside of the outer tank wall exposes the sensors and tracks to “normal atmosphere” at “normal” temperature.

In case of a metallic tank, the tank material is preferably aluminum which has a large coefficient of thermal expansion (CTE). Considering the large temperature range which the tank is exposed to from manufacturing to storage to operation, high stress and consequently cracks are to be avoided by handling a possible CTE mismatch.

One idea is to use the tank material itself as the base material for all conductors and insulators. For example, if the tank is made of aluminum the natural oxide layer (or as the case may be artificially created aluminum oxide) on the aluminum tank can be used as the insulator between individual conductor tracks. In an embodiment a further metal layer is deposited and structured on top of that insulator to constitute the electrical tracks. This metal layer is preferably again aluminum. The layer may be covered with a protective insulator. That insulator is preferably aluminum oxide (natural oxide or artificially created).

The metal tank can be used as a common electrical ground contact. Planar conductor configurations can be designed to allow for electrical shielding. This can be further improved if, preferably, additional layers of conductor and dielectric are added. This can allow the transport of high frequency signals, e.g., for RF antennas for LH₂ fuel gauging.

With only minor additional effort and weight, additional conductive tracks can be printed to establish a redundant electrical network. Robots can do the printing after the tank has been formed. If required, all that can be done alternatively already at the supplier of the metal sheet to avoid impact on lead time of the tank manufacturer.

In case of certain large CTE mismatch, the insulator of aluminum oxide can be replaced by a dielectric with more suitable CTE or with a CTE gradient. The rest of the ideas remain unchanged.

The conductive tracks can also be used to directly form an electrical capacitor such as an interdigital capacitor (IDC). This can be used for capacitive fuel level monitoring. Having an IDC with different spacing between the IDC fingers, i.e., different electrical capacitances, an array can be formed that addresses different measurement ranges.

Preferably, metal meanders can be used to form resistive temperature sensors.

The conductive tracks can also be used to directly form antenna elements for RF sensors. By doing so, a distributed antenna array can be established.

A preferred approach for (metal) layer deposition is cold spray deposition of (metal) powder. With this approach, the introduction of thermal energy into the tank material can be limited.

The ideas presented herein allow for a significantly reduced cabling effort in cryogenic tanks. They also allow for easier manufacturing of increased redundancy. Also, the integrated metal layers are multifunctional and are allowed to function as connections and sensors alike.

### BRIEF DESCRIPTION OF THE DRAWINGS

Embodiments of the invention are described in more detail with reference to the accompanying schematic drawings that are listed below. Therein:

FIG. 1 depicts an aircraft having a cryogenic tank;

FIG. 2 depicts a cross-section of the cryogenic tank; and

FIG. 3 depicts an embodiment of a layer structure.

### DETAILED DESCRIPTION OF THE PREFERRED EMBODIMENTS

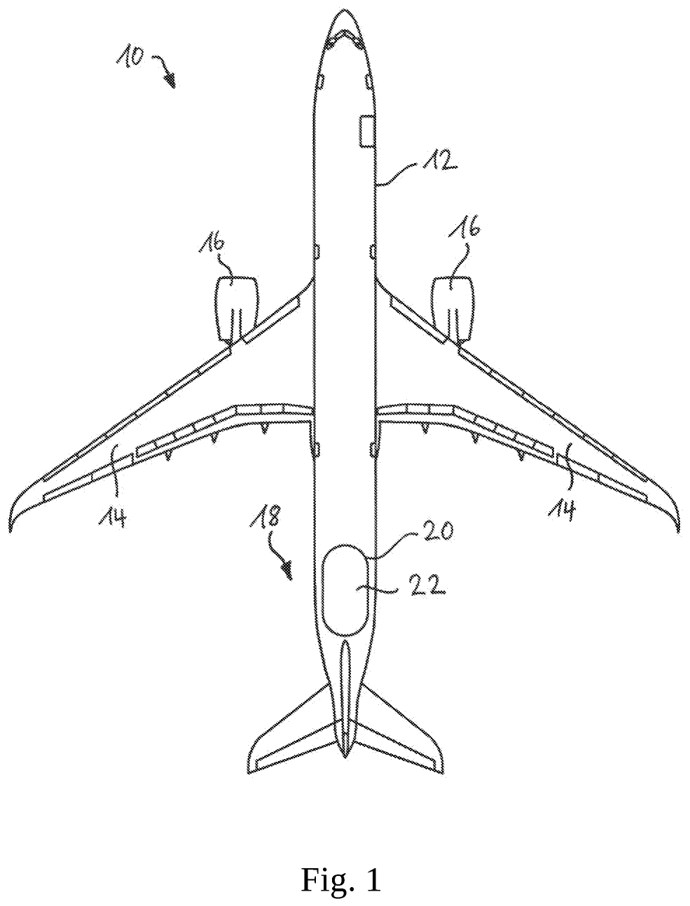

Referring to FIG. 1, an aircraft 10 comprises a fuselage 12. The aircraft 10 further comprises a pair of wings 14 that are attached to the fuselage 12. Furthermore, an engine 16 is attached to each wing 14.

The aircraft 10 comprises an aft section 18, which includes a horizontal and vertical tail plane. Furthermore, the aircraft 10 comprises a tank arrangement 20.

The tank arrangement 20 includes a cryogenic liquid tank 22 that is preferably arranged in the aft section 18. It should be noted that the liquid tank 22 may have a different shape and/or be located in a different section of the aircraft 10.

The tank 22 includes hydrogen fuel that can be directly fed to the engines 16. The hydrogen fuel may also be fed to fuel cells (not depicted) where the hydrogen is converted into electrical energy, and the electrical energy is then fed to the engines 16. The hydrogen fuel is stored in the tank 22 in the form of a cryogenic liquid, i.e., liquid hydrogen (LH₂).

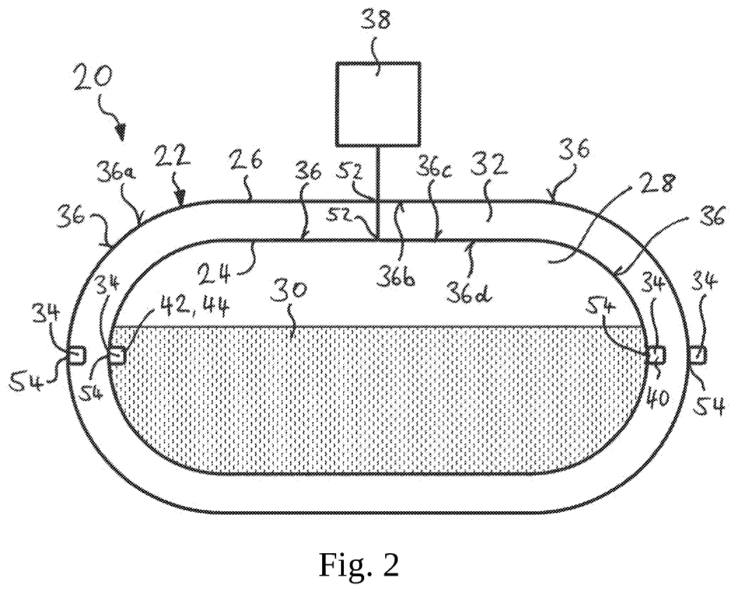

Referring to FIG. 2, the tank arrangement 20 is depicted in more detail. The tank 22 has an inner tank wall 24 and an outer tank wall 26. The inner tank wall 24 defines a storage volume 28 for a cryogenic liquid 30, here LH₂. It should be noted that the principles described herein may also apply to cryogenic tanks in general and not only those for aircraft 10.

The inner tank wall 24 and the outer tank wall 26 define a vacuum cavity 32. The vacuum cavity 32 holds a vacuum in order to improve thermal insulation of the storage volume 28.

In a manner known per se and therefore not depicted here for sake of brevity, hydrogen lines fluidly connect the storage volume 28 to the engines 16.

The tank 22 further comprises a plurality of sensors 34 that can be arranged on an inside or outside portion of the inner and outer tank walls 24, 26, respectively.

On each tank wall 24, 26 that has a sensor 34 an electrically conductive track structure 36 is integrally formed with the respective tank wall 24, 26. The electrically conductive track structure 36 electrically connects each sensor 34 to a control unit 38. The control unit 38 may be arranged anywhere in the aircraft 10, where control units are typically kept.

The control unit 38 is connected through the tank walls 24, 26 by suitable connectors that are known per se.

The sensor 34 may be integrated into the electrically conductive track structure 36 and have different configurations. In one embodiment, the sensor 34 may be formed as a meandering conducting path in order to form a resistor 40. The resistance of the resistor 40 can be determined by the control unit 38 thereby allowing a temperature measurement.

In another embodiment, two conducting paths made of different metals can join at a certain location forming a thermocouple.

In another embodiment, the sensor 34 may be formed as an interdigital structure. In this configuration the sensor 34 forms a capacitor 42. The capacity of the capacitor 42 can be determined by the control unit 38 thereby allowing measurements of the liquid level in the storage volume 28. In this case the sensor 34 is arranged on the inside of the inner tank wall 24 and may extend for a substantial portion along the inner tank wall 24.

In another arrangement the relative movement of the digits of the interdigital structure due to temperature and/or pressure changes can be used to determine the thermal expansion/contraction of the respective tank wall 24, 26 or the respective pressure within the enclosed volume be it storage volume 28 or vacuum cavity 32.

In another embodiment the sensor 34 may be formed as a radio frequency (RF) antenna 44. The RF antenna 44 can be controlled by the control unit 38 in order to measure liquid levels in a manner known per se.

In another embodiment the sensor 34 may be part of a sensor array (not depicted). The sensor array comprises a plurality of sensors 34 of the same type, e.g., resistors 40, capacitors 42 or RF antennas 44.

The sensor array may be configured such that temperature is measured at different locations at the same time. With this leaks can be not only detected but also located.

It should be noted that—while not shown in FIG. 2—the vacuum cavity 32 may include support elements that support the outer tank wall 26 with respect to the inner tank wall 24. The support elements may be made of the same material as the tank walls 24, 26 and may also have formed on them the electrically conductive track structure 36.

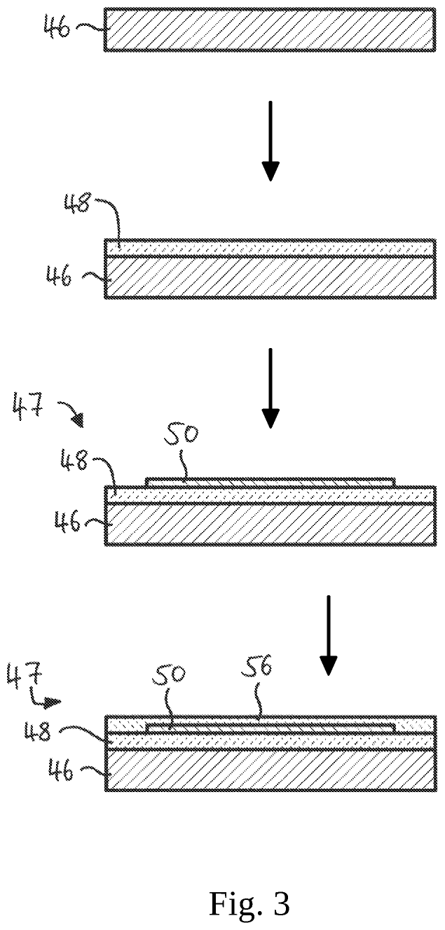

Referring to FIG. 3, a method for manufacturing the tank 22 is described in more detail.

A plate-like metal material 46 is provided. The plate-like metal material 46 serves as a substrate in a layer structure 47 to be formed. The plate-like metal material 46 is preferably an aluminum plate.

The plate-like metal material 46 is mechanically formed into a hollow tank body such that the plate-like metal material 46 becomes the inner tank wall 24. The hollow tank body is roughly cylindrical in shape, but may also have a different shape. The inside surface and the outside surface of the inner tank walls 24 is kept accessible such that the electrically conductive structure 36 may be formed thereon.

The same step is performed for the outer tank wall 26, which at this point is still a separate part from the inner tank wall 24.

An electrically insulating substrate layer 48 is provided on the inner and/or outer portions of the inner tank wall 24 and/or the outer tank wall 26 as desired. The electrically insulating substrate layer 48 preferably includes a metal oxide of the same metal material that is the plate-like metal material 46, such as aluminum oxide.

Depending on the metal material the electrically insulating substrate layer 48 can be formed naturally or artificially by anodization.

Next, an electrically conductive layer 50 is formed on top of the electrically insulating substrate layer 48. Preferably the electrically conductive layer 50 is made of the same material as the plate-like metal material 46, i.e., the inner and outer tank walls 24, 26.

The electrically conductive layer 50 is deposited to form the electrically conductive track structure 36. The electrically conductive layer 50 can be formed by a cold metal deposition process, such as cold spray deposition. The electrically conductive layer 50 can be formed by a galvanization process or a local galvanization process.

The electrically conductive track structure 36, as shown in FIG. 2, includes a plurality of electrically conducting paths 36a-d. Each conductive path 36a-d includes a first terminal 52 for connecting to a control unit 38 and a second terminal 54 for connecting to a sensor 34.

The electrically conductive layer 50 may be covered with a protective electrically insulating layer 56. The protective electrically insulating layer 56 may be formed by depositing an electrically insulating material, such as metal oxide. Preferably, the protective electrically insulating layer 56 is also deposited by a cold metal deposition process such as cold metal spraying. The protective electrically insulating layer 56 may also be made of the same material as the electrically insulating substrate layer 48.

The layer structure 47 includes a portion of the plate-like metal material 46 or respective inner or outer tank wall 24, 26, the electrically insulating substrate layer 48, the electrically conductive layer 50, and, optionally, the protective electrically insulating layer 56.

Further parts may be joined to the formed metal material 46, i.e., the inner or outer tank wall 24, 26 in order to completely form the respective tank wall 24, 26 as exemplified in FIG. 2. During this step the inner tank wall 24 is also inserted into the outer tank wall 26.

Where necessary and at any point during the process, the metal material 46 or inner and outer tank walls 24, 26 may be welded or the like in order to define and enclose the storage volume 28 or the vacuum cavity 32. Openings may be formed at the appropriate positions in the respective tank wall 24, 26 in order to allow for through connectors.

Support elements may be used, which may be prepared separately and are inserted into the vacuum cavity 32 to support the outer tank wall 26 relative to the inner tank wall 24. The support elements may also have formed on them the same layer structure 47. The support elements may get electrically connected to the conductive layer structure 36 on the tank walls 24, 26.

The invention provides improved measures for monitoring and manufacturing tanks for cryogenic liquids. It is proposed that the tank 22 is manufactured in a way that signal and power lines from a control unit 38 to sensors 34 of the cryogenic tank 22 are integrated with the tank walls 24, 26. The conductive track structure 36 so formed has a layer structure 47 that uses the naturally occurring or artificially generated insulating substrate layer 48 on the tank wall material as a substrate on top of which conductive paths 36-d are formed that connect the sensors 34 to the control unit 38.

The systems and devices described herein may include a controller, control unit or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems for detecting skew in a wing slat of an aircraft described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 aircraft
12 fuselage
14 wing
16 engine
18 aft section
20 tank arrangement
22 cryogenic liquid tank
24 inner tank wall
26 outer tank wall
28 storage volume
30 cryogenic liquid
32 vacuum cavity
34 sensor
36 electrically conductive track structure
38 control unit
40 resistor
42 capacitor
44 radio frequency (RF) antenna
46 plate-like metal material
47 layer structure
48 electrically insulating substrate layer
50 electrically conductive layer
36a electrically conducting path
36b electrically conducting path
36c electrically conducting path
36d electrically conducting path
52 first terminal
54 second terminal
56 protective electrically insulating layer

1. A cryogenic liquid tank for storing cryogenic liquids, such as liquid hydrogen, the tank comprising:
a tank body having at least one tank wall that defines a cryogenic storage volume for storing a cryogenic liquid at cryogenic temperatures; and
an electrically conductive track structure that is formed on or attached to the at least one tank wall and configured for conducting electricity from a terminal to a sensor.

2. The tank of claim 1, further comprising at least one sensor that is electrically coupled to the electrically conductive track structure and arranged on the tank wall.

3. The tank of claim 2, wherein the at least one sensor is integrally formed with the conductive track structure.

4. The tank of claim 2, wherein the at least one sensor is chosen from a group consisting of:
a capacitive sensor configured for changing its capacitance depending on a physical characteristic relating to the cryogenic liquid;
a resistive sensor configured for changing its resistance depending on a physical characteristic relating to the cryogenic liquid;
a thermocouple sensor configured for generating a voltage depending on a temperature relating to the cryogenic liquid; and
a radiofrequency sensor configured for transmitting, receiving, or transceiving radio waves, so as to allow measuring a physical characteristic relating to the cryogenic liquid.

5. The tank of claim 1, wherein the at least one tank wall comprises an inside portion that faces towards the storage volume and an outside portion that faces away from the storage volume, wherein the electrically conductive track structure is formed on at least one of the inside portion or outside portion.

6. The tank of claim 1, wherein the tank body comprises an inner tank wall and an outer tank wall, wherein the inner tank wall defines the storage volume, and the electrically conductive track structure is formed on at least one of the inner tank wall or the outer tank wall.

7. The tank of claim 1, wherein the tank body comprises a vacuum cavity that encompasses the storage volume and holds a vacuum.

8. The tank of claim 1, wherein the tank body and the electrically conductive track structure form a layer structure.

9. The tank of claim 8, wherein the layer structure comprises an electrically insulating substrate layer that is part of or formed on the at least one tank wall and an electrically conductive layer formed on the electrically insulating substrate layer so as to be electrically insulated from the at least one tank wall.

10. The tank of claim 8 wherein the layer structure comprises a protective electrically insulating layer formed on top of an electrically conductive layer.

11. A tank arrangement for an aircraft, the tank arrangement comprising a tank according to claim 1 and a control unit that is electrically coupled to the electrically conductive track structure and configured for measuring physical parameters that relate to the cryogenic liquid.

12. An aircraft comprising a tank according to claim 1.

13. An aircraft comprising a tank arrangement according to claim 11.

14. A method for manufacturing a cryogenic liquid tank for storing cryogenic liquids, the method comprising:
a) forming a tank body that has least one tank wall, out of metal material;
b) forming an electrically conductive track structure on the at least one tank wall of a cryogenic liquid tank, such that the electrically conductive track structure is suitable for conducting electricity from a terminal to a sensor; and
c) closing the tank wall so as to define a cryogenic storage volume for storing a cryogenic liquid at cryogenic temperatures;
or
d) forming an electrically conductive track structure on a piece of plate-like metal material, such that the electrically conductive track structure is suitable for conducting electricity from a terminal to a sensor; and subsequently
e) forming the metal material into the tank body that has least one tank wall to define a cryogenic storage volume for storing a cryogenic liquid at cryogenic temperatures.

15. The method according to claim 14, wherein the tank body is formed out of at least one piece of plate-like metal material.

16. The method according to claim 14, wherein at least one of step b) or step d) comprises oxidizing or letting oxidize the metal material to form an insulating substrate layer.

17. The method according to claim 16, wherein at least one of step b) or step d) comprises deposition of conductive material on the electrically insulating substrate layer to form an electrically conductive layer.

18. The method according to claim 15 further comprising a step f) of forming at least one sensor that is electrically coupled to the electrically conductive track structure on the piece of plate-like metal material.

19. The method according to claim 14 further comprising a step f) of forming at least one sensor that is electrically coupled to or the tank wall.
